(19) United States
(12) Patent Application Publication
(10) Pub. No.: US 2009/0037994 A1
(43) Pub. Date: Feb. 5, 2009

(54) SYSTEM AND METHOD FOR ORDERED CREDENTIAL SELECTION

(75) Inventor: Duane Buss, West Mountain, UT (US)

Correspondence Address: HAYNES AND BOONE, LLP;IP Section, 2323 Victory Avenue, Suite 700, Dallas, TX, 75219, US

(73) Assignee: NOVELL, INC., Provo, UT (US)

(21) Appl. No.: 11/830,492

(22) Filed: Jul. 30, 2007

(51) Int. Cl. G06F 7/04

(52) U.S. Cl. 726/9

(57) ABSTRACT

A system and method for assisting in ordered credential selection is disclosed. In one embodiment, the system enables ordered credential selection for credentials associated with one or more digital identities. The system comprises a plurality of security tokens, with each security token comprising a claim associated with a digital identity and where at least two of the security tokens are different from each other. The system also comprises an ordering module and manager module. The ordering module imposes a preferential ordering on the security tokens in accordance with an ordering policy to select a preferred security token. The manager module transmits at least one security token in response to a request, where at least one of the security tokens transmitted by the manager module is the preferred security token.

### BACKGROUND

Digital identity refers generally to the way entities represent who they are as they engage in electronic transactions. However, current identity systems are fractured and do not deal effectively with the various contexts in which we deal with identity information. Different contexts require different identities—or different expressions of identity information—all of which must still accurately represent the underlying reality that the various identities represent.

Recent developments in digital identity systems focus around the creation of identity metasystems—cooperating identity systems that work together in multiple contexts. Recent examples include Windows Cardspace, OpenID, and LID. The goal of these technologies is to let people use digital identities easily, effectively and securely.

### SUMMARY

A system and method for assisting in ordered credential selection is disclosed. In one embodiment, the system enables ordered credential selection for credentials associated with one or more digital identities. The system comprises a plurality of security tokens, with each security token comprising a claim associated with a digital identity and where at least two of the security tokens are different from each other. The system also comprises an ordering module and manager module. The ordering module imposes a preferential ordering on the security tokens in accordance with an ordering policy to select a preferred security token. The manager module transmits at least one security token in response to a request, where at least one of the security tokens transmitted by the manager module is the preferred security token.

### DESCRIPTION OF THE DRAWINGS

FIG. 1 illustrates a security token for implementing a digital identity in accordance with one embodiment.

FIG. 2 is a diagram of an identity system in which one or more embodiments described herein may be implemented.

FIG. 3 is a high-level diagram of interactions among a user, a relying party, and an identity provider in accordance with one embodiment.

FIG. 4 is a flowchart illustrating interactions between a user and an RP in accordance with one embodiment.

FIG. 5 illustrates a credential ordering and selection screen in accordance with one embodiment.

### DETAILED DESCRIPTION

Digital identity systems are most frequently used in the context of all-electronic transactions, but the increasing automation of daily commerce makes digital identity applicable to real-world systems such as RFID passports, touchless credit card transactions, smartcard or SecurID-enabled transactions, or payment via cell phone or PDA. Such hybrid transactions occur partially in the “real-world” and partially within one or more computers. Despite the description of one or more embodiments in terms of intra-computer components, such hybrid transactions are explicitly contemplated.

For ease of explanation, various embodiments will be described in terms of “modules” that can be implemented in hardware, software, or a combination of both. These modules may be general-purpose, or they may have dedicated functions such as memory management, program flow, instruction processing, object storage, etc. The modules could be implemented in any way known in the art. For example, in one embodiment a module is implemented in a hardware circuit comprising custom VLSI circuits or gate arrays, off-the-shelf semiconductors such as logic chips, transistors, or other discrete components. One or more of the modules may also be implemented in programmable hardware devices such as field programmable gate arrays, programmable array logic, programmable logic devices or the like.

In another embodiment, one or more of the modules are implemented in software for execution by various types of processors. An identified module of executable code may, for instance, comprise one or more physical or logical blocks of computer instructions that may, for instance, be organized as an object, procedure, or function. Further, the executables of an identified module need not be physically located together, but may comprise disparate instructions stored in different locations that, when joined logically together, comprise the module and achieve the stated purpose for the module. A “module” of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Another embodiment uses higher-level components as modules. For example, a module may comprise an entire computer acting as a network node. A module may also comprise an off-the-shelf or custom program, such as a database management system. These higher-level modules may be decomposable into smaller hardware or software modules corresponding to different parts of a software program and identifiable chips (such as memory chips, ASICs, or a CPU) within a computer.

To better illustrate the advantages and features of various embodiments, a particular description of several embodiments will be provided with reference to the attached FIGS. 1-5. These drawings illustrate only selected portions of selected embodiments sufficient for one skilled in the art to understand the underlying concepts presented. For ease of explanation only, and not by way of limitation, most examples will be described in the context of a Cardspace implementation using SOAP over HTTP for messaging and WS-Security, WS-Trust, WS-MetadataExchange, and WS-SecurityPolicy for policy and data manipulation. Using these standards, it is possible to define a consistent way to work with any digital identity created by any source, using any identity technology; however, these technologies are not necessary to any particular embodiment. For example, another embodiment may use X.509 certificates and Kerberos tickets to represent identity claims. Yet another embodiment may use SSL certificates with an HTTP transport. Still another embodiment may use RFID and a public/private key infrastructure.

Like identities in the real world, digital identities come with different characteristics and serve different purposes. An account with a webmail provider, for example, may be identified by an email address. An account with a bank or other organization may be represented by a username and password. A work account may have a username, password, and one or more directory entries associated with it.

Each of these identities serves a different purpose and is valid in a different context. It is common to associate different information with different identities; for example, the identity used for a fantasy football tracker may associate a user with the name of a favorite team; an identity used for work probably associates a user with a social security number, employee ID, etc. It is generally desirable to keep the information associated with each identity separate; for example, it is not advisable to give a fantasy football website a social security number.

Digital identities also vary in how difficult they are to obtain. For example, a fantasy football identity is easy to obtain; the associated website may only need an arbitrary username and password. Obtaining a digital identity from an employer is more difficult; it typically may require cross-checks within several databases and the approval of multiple administrators and human resource professionals.

FIG. 1 illustrates one embodiment of a security token used to implement a digital identity. The security token 100 comprises one or more claims 110. Each of the claims 110 represents some aspect of a digital identity. For example, in one embodiment, one of the claims 110 may represent or contain a username. In another embodiment, one of the claims 110 may contain demographic information. In yet another embodiment, one of the claims 110 may include sensitive information such as a social security or credit card number. In general, any statement of interest can be encoded into or included in one of the claims 110.

In various embodiments it is advantageous to provide one or more pieces of information that serve to establish a connection between the entity presenting the claims and some trusted person, process, or thing. To establish that connection, one or more proofs 120 can be included along with the security token. In one embodiment, a proof 120 contains a password. Another embodiment signs the claims using a private key and then provides a corresponding public key. Yet another embodiment of a proof 120 wraps the claims in a certificate. Still another embodiment uses multiple proofs, thereby enabling receivers, or “relying parties,” to verify that the claims are being made by someone for whom the claims are true.

Various embodiments of claims and proofs are contemplated. One embodiment uses text strings. Other embodiments use X.509 certificates, Kerberos tickets, and/or SAML.

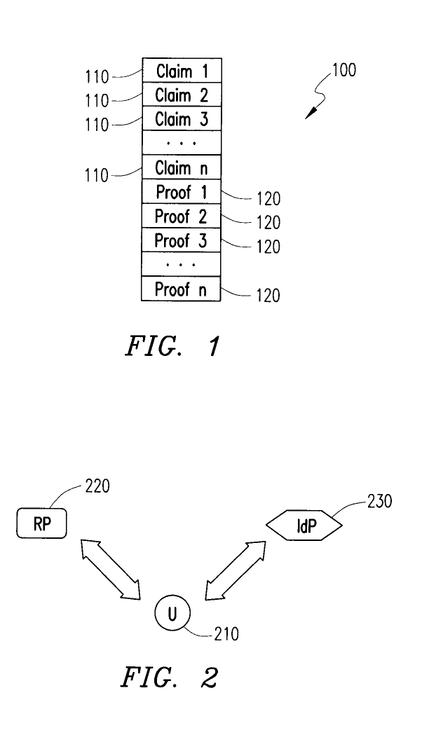

FIG. 2 is a diagram of an identity system that could benefit from one or more embodiments described herein. The object labeled 210 is the user; i.e., the entity that is associated with a digital identity. For purposes of explanation only, it is assumed that the user is a person. In other embodiments, the user 210 may be an organization, application, machine, or other real-world subject needing to make a claim.

The object labeled 220 is the relying party (RP). A relying party is an application, process, or user that in some way relies on a digital identity. In one embodiment, the RP 220 uses the claims in the security token to authenticate the user 210. In a second embodiment, the RP 220 uses the claims to authorize some action by the user 210. The relying party can also use the claims to get a credit card number, favorite football team, or other information relevant to the user 210.

Because different relying parties have different requirements, the RP 220 may communicate a security policy to the user 210. This security policy defines the type of claims and proofs that the RP 220 will accept. Different embodiments are expected to define different combinations of claims and proofs. Some embodiments scale their reliance and the authorization given to the user based upon the claims and proofs provided.

The object labeled 230 is an identity provider (IdP). An identity provider is an entity that provides a digital identity for a user 210. Multiple IdPs are contemplated within a single system. In one embodiment, an employer-controlled directory service is used as an IdP 230. In another embodiment, a government agency acts as an IdP. In another embodiment, a third party acting through a website acts as an IdP. In yet another embodiment, the user 210 also acts as an IdP 230, creating a self-issued identity.

It is appreciated that the model shown in FIG. 2 has been simplified for purposes of illustration; a fully functioning identity system will usually have multiple users 210, RPs 220 and IdPs 230. In one embodiment, a single application is used to manage multiple identities. In another embodiment, a single application is used to manage multiple security tokens, each with different claims and proofs, as part of a single digital identity.

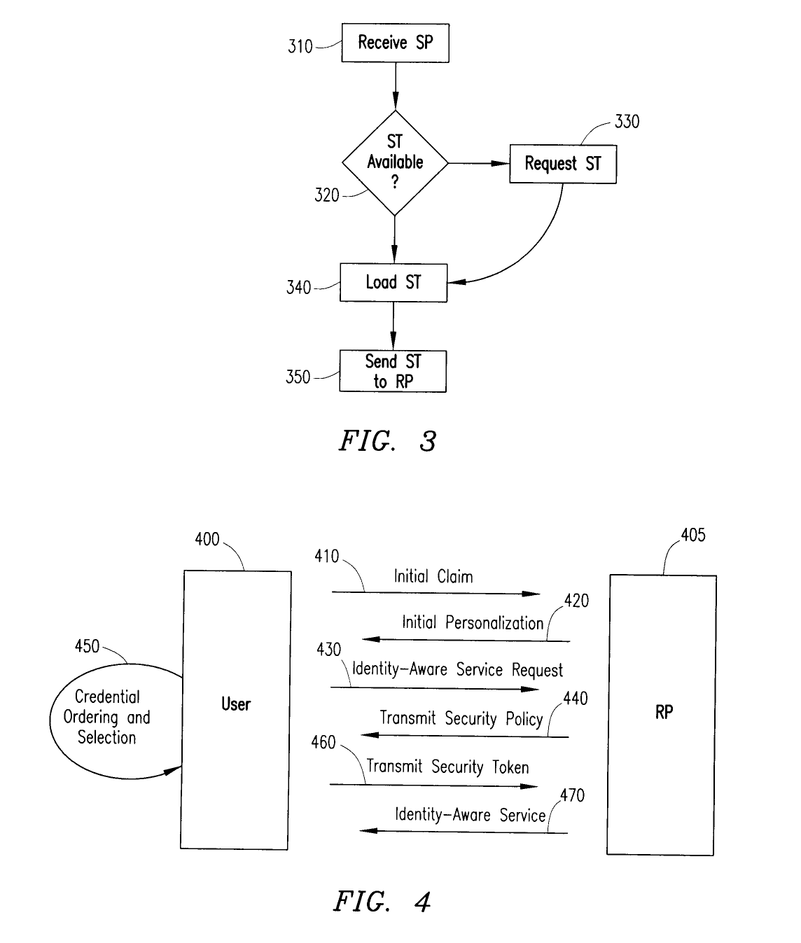

FIG. 3 is a high-level diagram of the interactions between the user 210, the RP 220 and the IdP 230 according to one embodiment. The embodiment illustrated in FIG. 3 includes a manager module that can interact with the real-world entity (a person). The manager model acts as the user 210. The RP 220 and IdP 230 are implemented as modules communicating over the network; their implementation is opaque and not relevant to the current discussion. At step 310, the manager module receives security policy from the RP 220. The security policy contains requirements about what security token formats the RP will accept, what claims the security token must contain, and what proofs must be included along with the claims. These requirements may be presented in human-readable text for the user or in a computer-parsable format for interpretation by a computing module.

At step 320, the manager module takes the details specified in the security policy and searches for an appropriate security token. If an appropriate security token has already been given to the manager module, then that security token is retrieved and processing proceeds to step 340. If an appropriate security token has not been given to the manager module, the manager module then proceeds to step 330. In an embodiment in which multiple security tokens may conform to the given security policy, all matching security tokens may be retrieved.

At step 330, the manager module requests a conforming security token from an IdP 230. Because the details of the required security token are specified by the RP 220, the specific representation of the claims and proofs will vary according to the RP 220 and IdP 230 actually used. As stated above, however, there is no intrinsic limitation on the representation of the claims or proofs. In an embodiment in which multiple security tokens may conform to the given security policy, multiple tokens may be requested.

At step 340, the retrieved/received security token is loaded by a loader module within the manager module. In an embodiment in which multiple security tokens may conform to the given security policy, multiple tokens may be loaded. An expert system, ruleset, or an operator can be consulted as to the optimal security token to use.

At step 350, the selected security token(s) are passed to the RP by a transmitter module in the manager module. The relying party can then use this token to authenticate the user or for some other purpose.

As noted above, real-world identity is complex; different people use different identity credentials in different contexts. Digital identities can be made easier to use by making them function more like real-world identity systems. Accordingly, security tokens and proofs can be bound together into abstract “cards” that function like real-world ID cards, such as driver's licenses and credit cards. Unlike many real-world identity cards, however, digital identity cards present substantially greater challenges to personal security and privacy. For example, driver's licenses are commonly used to proof of age. In this case, the person holding the license is the user; the government that issued the license acts as the IdP; and the retailer accepting the license is the RP. When a person presents the license to a retailer, the state government is generally not notified and the information from the license is not generally stored by the retailer in a customer database.

Digital identities, on the other hand, do have the property that IdPs may frequently be notified of identity use, and retailers routinely will store the information from the identity in a customer database. Further, customer demographic and purchasing data is considered a marketable asset by many companies working online; that data is regularly sold or otherwise transferred to third parties without the knowledge of the person to whom the identity information pertains.

Because of the substantial potential for abuse, digital identity systems can use a credential ordering and selection procedure that uses rules to select the optimal card for presentation to an RP.

FIG. 4 is a flowchart showing the interaction between a user 400 and an RP 405 according to one embodiment. Assume the user 400 has many potential credentials available, and for security and privacy purposes wishes to use a minimum-knowledge policy when interacting with online entities.

At step 410 the user 400 desires to interact with the RP 405 on a very basic level. Accordingly, the user 400 can send the RP 405 an initial claim consisting of very basic information, such as a username only. This claim is analogous to the information persisted today in web browsers via cookies. In one embodiment, the initial claim is provided as a cookie header in an HTTP request. In a second embodiment, a specific webservice is used to provide this initial token. This token may be self-issued or issued by some other IdP.

At step 420, the initial claim is sufficient for the RP 405 to provide some level of personalization. For example, one embodiment maps this initial claim to the user's username or site preferences. At many sites, nothing more than this initial claim and personalization may be needed. Assume, however, that further services from the RP 405 are desired. At step 430, the user 400 requests the additional services from the RP 405.

If the initial claim provided by the user 400 is insufficient, the RP 405 can respond at step 440 by transmitting a security policy for the user 400. For example, in one embodiment the initial claim is a username. The additional service is the purchase of some good or service. The security policy transmitted by the RP 405 includes the requirement that “credit card number,” “address” and “real name” claims be provided to complete the purchase.

At step 450, the user 400 undergoes credential ordering and selection. The ordering imposed on the credentials varies according to the implementation of the ordering module and the preferences and rules input by the user 400. For example, one embodiment uses a constraint framework to limit the available credentials to the tokens that would conform to the security policy. The available tokens are then ordered according to how much information they contain. Another embodiment uses the user's historical information to track what claims and tokens have been previously presented; the tokens are ordered according to their frequency of use in equal or similar situations. Another embodiment uses a rules engine to derive the optimal token; the user is allowed to input preferences such as “give only the minimum information possible” and “prefer this credit card” to guide the rules engine. Yet another rembodiment values consistency; the actual data values passed in previous exchanges are queried, and the token with the most consistent values is sorted highest. Still another embodiment prefers lower-value tokens for RPs with whom the user has little history and higher-value tokens for RPs with whom the user has a long history. Another embodiment uses digital reputations to order the tokens. Another embodiment uses a ranking service or other information provided by a third party over the network. Another embodiment allows many different factors, with the user assigning the weight given to each factor.

At step 460, the selected, or “preferred,” security token is transmitted to the RP, and at step 470 the RP 405 responds with the requested identity-aware service.

By analogy, assume a situation in which a user is buying something from a physical store with a physical set of identity and credit cards. Many people keep track of the balances on various credit cards and use the card with the lowest balance. Other people use one card to buy gas, a second to buy groceries, and a third to buy clothes because of different rewards programs available in conjunction with certain uses of the card. Further, some retailers may only accept certain credit cards if the name on the card matches the name on the user's driver's license. All these are ordering criteria, and each criterion may be given a different weight by a particular user in a particular situation. Assume that the user's wallet knew about the ordering criteria and was able to reconfigure itself so that in each situation, the card on top of the others is the preferred card.

In one contemplated embodiment, a cell phone, PDA, or “smart wallet” is able to keep track of security tokens corresponding to credit cards. When the user wants to complete a transaction, for example, using a call-to-buy or touchless credit card system, the smart wallet interprets the request for payment as a security policy, sorts the security token/cards according to the given ordering criteria, and transmits the preferred card information automatically.

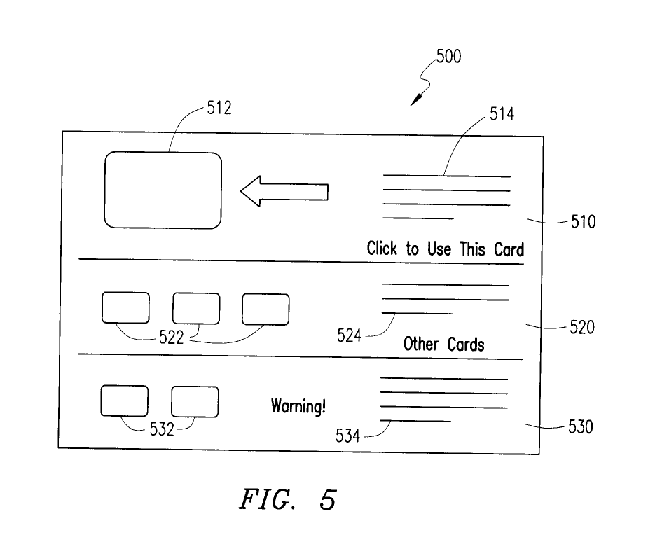

FIG. 5 shows a credential ordering and selection screen according to one embodiment. The selection screen, designated generally by reference numeral 500, is launched in a protected process to prevent phishing or spoofing using the identity selection screen. To express the recommended ordering, the screen is divided into different sections, designated by reference numerals 510, 520 and 530.

Objects 512, 522, and 532 in the section 520 are security tokens. In the illustrated embodiment, each of the objects 512, 522, 532, corresponds to a card representing a digital identity that the user can present to an RP. By selecting a particular card, the user is actually choosing a specific security token with a specific set of claims created by a specific IdP. The technical complexity is hidden, however, and the user is encouraged to think of the various available security tokens in the same sense as physical cards.

Section 510 is the “Recommended” section. The security tokens displayed here were ordered first according to earlier-provided criteria. The object 512 representes the highest-ordered card and the one that is recommended for use. In one embodiment, a lowest-priority total ordering is imposed on the cards so that one card is always sorted highest. Thus, only one card is presented as the recommended card, even if, absent the imposed total ordering, multiple cards would sort equally high. In a second embodiment, all cards ranking above a certain threshold, or equal to each other, are displayed in section 510.

Text 514 is a description concerning the recommended card or cards. In one embodiment this is a description of the information associated with the recommended card or cards. In a second embodiment, this is a description of the RP's security policy. In a third embodiment, this is a description of the ordering imposed on the cards.

Section 520 is the “Available” section. The objects 522 represent cards that are available and conform to the security policy, but for some reason did not sort as highly as the card represented by the object 512. Text 524 is a description concerning the card or cards, similar to the description provided by text 514.

Section 530 is the “Warning” section. The cards represented by the objects 532 are available and conform to the security policy, but some aspect of the cards violates a local policy. For example, if the RP is unknown, has a low digital reputation, or displays signs associated with untrustworthiness, it would be inadvisable to give a high-value card to that RP even if the card conformed to the RP's security policy. In another embodiment, these cards are hidden so as to prevent local policy violations. Text 534 is a description concerning the card or cards, similar to the description provided by text 514.

The embodiments shown in the drawings and the other embodiments described herein, only illustrate selected aspects of the embodiments and are not intended to limit the scope thereof. Despite reference to specific features illustrated in the example embodiments, it is nevertheless understood that these features are not essential to all embodiments and no limitation of the scope thereof is thereby intended. Possible alterations, modifications, and applications of the principles described herein have been omitted for clarity and brevity; nevertheless, it is understood that such alterations, modifications, and applications are contemplated. Furthermore, some items are shown in a simplified form, and inherently include components that are well known in the art. Further still, some items are illustrated as being in direct connection for the sake of simplicity. Despite the apparent direct connection, it is understood that such illustration does not preclude the existence of intermediate components not otherwise illustrated.

What is claimed is:

1. A system for enabling ordered credential selection wherein the credential is associated with a digital identity, the system comprising:
a plurality of security tokens, wherein each security token comprises a claim regarding a digital identity and at least two of the security tokens are different from each other;
an ordering module adapted to impose a preferential ordering on the plurality of security tokens in accordance with an ordering policy to select a preferred security token;
a manager module adapted to transmit at least one of the security tokens in response to a request;
wherein at least one of the security tokens transmitted by the manager module is the preferred security token.

2. The system of claim 1 wherein the request further comprises a security policy and wherein the ordering module imposes the preferential ordering on subset of security tokens taken from the plurality of security tokens, wherein a token from the plurality of security tokens is put into the subset of security tokens if the security token conforms to the security policy.

3. The system of claim 1 wherein one of the plurality of security tokens comprises a proof.

4. The system of claim 1 wherein the manager module is further adapted to requesting at least one of the plurality of security tokens from an identity provider.

5. The system of claim 1 wherein the ordering module comprises at least one of a constraint framework, a historical information tracker, a rules engine, a consistency checker, a value sorter, a reputation checker, a ranking service, a webservice endpoint, a user-provided rule checker, and a differential weighter.

6. The system of claim 1 wherein the ordering policy comprises a plurality of rules, wherein the rules specify at least one of conforming to constraints, evaluating historical usage, using a rules engine, checking for consistency, determining high and low-value credentials, determining site trust level, evaluating a digital reputation, consulting a ranking service, consulting a web service, consulting an operator, and weighting multiple factors according to given criteria.

7. The system of claim 1 further comprising a graphical user interface (GUI) for displaying the plurality of security tokens ordered according to the preferential ordering.

8. A system for enabling ordered credential selection wherein the credential is associated with a digital identity, the system comprising:
a plurality of security tokens, wherein each security token comprises a claim regarding a digital identity and at least two of the security tokens are different from each other;
an ordering module adapted to impose a preferential ordering on the plurality of security tokens in accordance with an ordering policy to select a preferred security token; and
a user interface (UI) adapted to display a representation of each of the plurality of security tokens ordered according to the preferential ordering;
wherein the UI is adapted to receive an input from an operator, the input comprising security token selection information.

9. The system of claim 8 wherein the UI further comprises one of a recommended section, an available section, and a warning section.

10. The system of claim 8 wherein the UI further comprises a description of one of a security token, the preferential ordering, and the preferred security token.

11. The system of claim 8 wherein the UI is a graphical user interface displayed on a computing system and the input from the operator comes from a pointer device.

12. The system of claim 8 further comprising a security policy and wherein the ordering module imposes the preferential ordering on subset of security tokens taken from the plurality of security tokens, wherein a token from the plurality of security tokens is put into the subset of security tokens if the security token conforms to the security policy.

13. The system of claim 12 wherein the display of the plurality of security tokens only comprises security tokens conforming to the security policy.

14. The system of claim 8 wherein the ordering policy comprises a plurality of rules, wherein the rules specify at least one of conforming to constraints, evaluating historical usage, using a rules engine, checking for consistency, determining high and low-value credentials, determining site trust level, evaluating a digital reputation, consulting a ranking service, consulting a web service, consulting an operator, and weighting multiple factors according to given criteria.

15. A method for enabling ordered credential selection wherein the credential is associated with a digital identity, the method comprising:
responsive to a request, loading a plurality of security tokens, wherein each security token comprises a claim regarding a digital identity and at least two of the security tokens are different from each other;
ordering the plurality of security tokens in accordance with an ordering policy;
determining a preferred security token;
transmitting a response to the request, wherein the response comprises the preferred security token.

16. The method of claim 15 wherein the determining a preferred security token comprises receiving selection information from an operator.

17. The method of claim 15 wherein the loading a plurality of security tokens comprises comparing each security token against a security policy and not loading the security token if it does not conform to the security policy.

18. The method of claim 15 further comprising showing a user interface (UI) to an operator and receiving selection information from the operator.

19. The method of claim 18 further comprising hiding at least one security token from the operator.

20. The method of claim 15 wherein the ordering policy comprises a plurality of rules, wherein the rules specify at least one of conforming to constraints, evaluating historical usage, using a rules engine, checking for consistency, determining high and low-value credentials, determining site trust level, evaluating a digital reputation, consulting a ranking service, consulting a web service, consulting an operator, and weighting multiple factors according to given criteria.
